(19) United States
(12) Patent Application Publication
(10) Pub. No.: US 2025/0385865 A1
(43) Pub. Date: Dec. 18, 2025

(54) NETWORK DEVICE AND PROCESSING METHOD WITH SERVICE FUNCTION CHAIN

(71) Applicant: O'PRUEBA TECHNOLOGY INC., Hsinchu City (TW)

(72) Inventors: Ting-Qian Bai, Hsinchu City (TW); Chun-Hung Hsu, Hsinchu City (TW)

(21) Appl. No.: 19/228,395

(22) Filed: Jun. 4, 2025

(30) Foreign Application Priority Data
Jun. 12, 2024 (TW) 113121735

(51) Int. Cl. H04L 45/00; H04L 45/74

(52) U.S. Cl. CPC H04L 45/34; H04L 45/74

(57) ABSTRACT

A network device and processing method with a service function chain provided. The network device includes a physical network interface, a storage unit, and a processing unit. The storage unit stores virtual service nodes and a virtual bridge. The virtual bridge connects to the virtual service nodes, which form a service function chain according to sequence. Virtual service nodes include an endpoint network configuration. The processing unit connects to the physical network interface and storage unit, and forwards an input packet into the service function chain. The processing unit identifies the virtual service node obtaining the input packet as a current node and the adjacent virtual service node as a destination node, where the current node modifies the input packet and sends the modified packet via the virtual bridge to the destination node, until an output packet is generated by the service function chain after traversing all virtual service nodes.

### CROSS-REFERENCE TO RELATED APPLICATION

This non-provisional application claims priority under 35 U.S.C. § 119(a) to Patent Application No. 113121735 filed in Taiwan, R.O.C. on Jun. 12, 2024, the entire contents of which are hereby incorporated by reference.

### BACKGROUND

### Technical Field

The disclosure relates to an electronic device and a processing method, and in particular to a network device and processing method with a service function chain.

### Related Art

With the rapid development of integrated circuits, the computing power of electronic devices can be greatly improved. Therefore, multiple virtual network functions can be provided by a same network device. Virtual network functions can be concatenated according to different sequences to form a service function chain, such that the inputted network packet sequentially flows through the virtual network functions.

To deploy multiple virtual network functions, the engineers are required not only to be familiar with the relevant settings of the network function, but also to have knowledge of how the virtual environment is deployed. In particular, the deployment of different virtual network functions can be realized by corresponding open source projects. However, different open source projects have different related environments and different virtual platforms. This causes an increased cost for engineers during deployment or subsequent maintenance.

### SUMMARY

In view of this, in an embodiment, a network device with a service function chain is provided. The network device has a physical network interface, a storage unit, and a processing unit. The physical network interface receives an input packet or sends an output packet. The storage unit stores a plurality of virtual service nodes and a virtual bridge. The virtual bridge connects to the virtual service nodes. The virtual service nodes form a service function chain according to their sequence. Each of the virtual service nodes has an endpoint network configuration. The processing unit connects to the physical network interface and the storage unit. The processing unit executes the virtual service nodes and the virtual bridge. The processing unit forwards the input packet into the service function chain. The virtual service node obtaining the input packet is a current node, and the next virtual service node adjacent to the current node is a destination node. The current node modifies the input packet according to an endpoint network configuration of the destination node, and the current node sends the modified input packet via the virtual bridge to the destination node until the output packet is generated by the service function chain after traversing all the virtual service nodes.

In an embodiment, the processing unit establishes a virtual wide area network interface. The virtual wide area network interface connects to the physical network interface and the service function chain through a network. The virtual wide area network interface performs a NAT program on the input packet to modify a network address of the input packet. The virtual wide area network interface sends the modified input packet to the service function chain.

In an embodiment, an end node of the service function chain sends the output packet to the virtual bridge. The virtual bridge performs the NAT program on the output packet to modify the network address of the output packet. The virtual bridge sends the modified output packet to the physical network interface.

In an embodiment, the virtual service nodes at two ends of the service function chain are respectively a head node and an end node. The head node receives the input packet, and the end node sends the output packet.

In an embodiment, the processing unit refers to an end network address of the endpoint network configuration of the end node and writes the end network address into a head source address of the input packet, and the head node receives the input packet.

In an embodiment, each of the virtual service nodes is configured with a respective network function.

In an embodiment, a plurality of virtual service nodes are configured in a network device and form a service function chain according to their sequence, and a processing method with a service function chain includes: receiving, by the network device, an input packet, and forwarding the input packet into the service function chain; taking the virtual service node obtaining the input packet as a current node and the next virtual service node adjacent to the current node as a destination node; modifying, by the current node, the input packet according to an endpoint network configuration of the destination node; sending, by the current node, the modified input packet to a virtual bridge such that the virtual bridge sends the input packet to the destination node; generating, by the service function chain, an output packet according to the input packet after the input packet traverses all the virtual service nodes; and outputting, by the service function chain, the output packet via a physical network interface.

In an embodiment, the receiving, by the network device, the input packet, and forwarding the input packet into the service function chain includes: establishing, by the network device, a virtual wide area network interface; receiving, by the virtual wide area network interface, the input packet, and performing, by the virtual wide area network interface, a NAT program on the input packet to modify a network address of the input packet; and sending, by the virtual wide area network interface, the modified input packet to the service function chain.

In an embodiment, the generating, by the service function chain, the output packet according to the input packet after the output packet traverses all the virtual service nodes includes: sending, by an end node of the service function chain, the output packet to the virtual bridge; performing, by the virtual bridge, the NAT program on the output packet to modify the network address of the output packet; and sending, by the virtual bridge, the modified output packet to the physical network interface.

In an embodiment, the processing method with a service function chain further includes: obtaining, by the network device, an end network address of the endpoint network configuration of the end node; writing, by the network device, the end network address into a head gateway address of the input packet; and sending, by the network device, the modified input packet to the head node.

The network device and processing method with a service function chain not only provide the service function chain that can be deployed rapidly, but also enable the input packet to be transmitted layer by layer according to the sequence of the virtual service nodes, thereby reducing the service deployment cost of engineers for the network device.

### BRIEF DESCRIPTION OF THE DRAWINGS

FIG. 1 is a schematic diagram showing hardware architecture of a network device with a service function chain according to an embodiment.

FIG. 2 is a schematic structural diagram of virtual service nodes and a service function chain according to an embodiment.

FIG. 3 is a schematic flowchart showing processing of the network device with a service function chain according to an embodiment.

FIG. 4 is a schematic diagram showing concatenation of virtual nodes of the service function chain according to an embodiment.

FIG. 5 is a schematic diagram showing architecture of a service device according to an embodiment.

FIG. 6 is a schematic diagram showing changes of network addresses of the virtual service nodes according to an embodiment.

### DETAILED DESCRIPTION

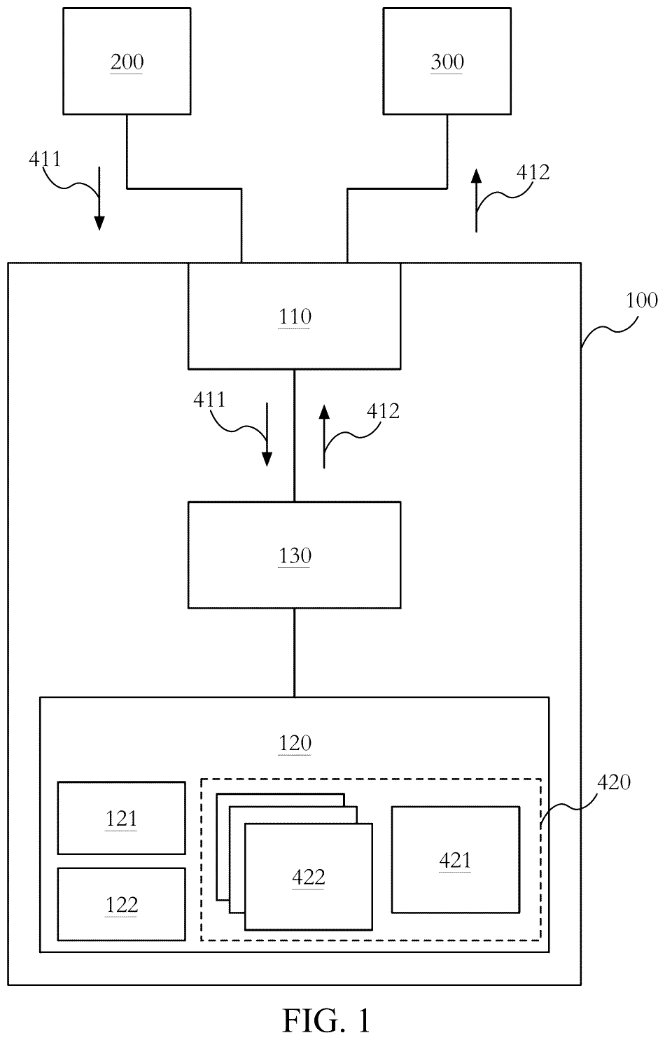

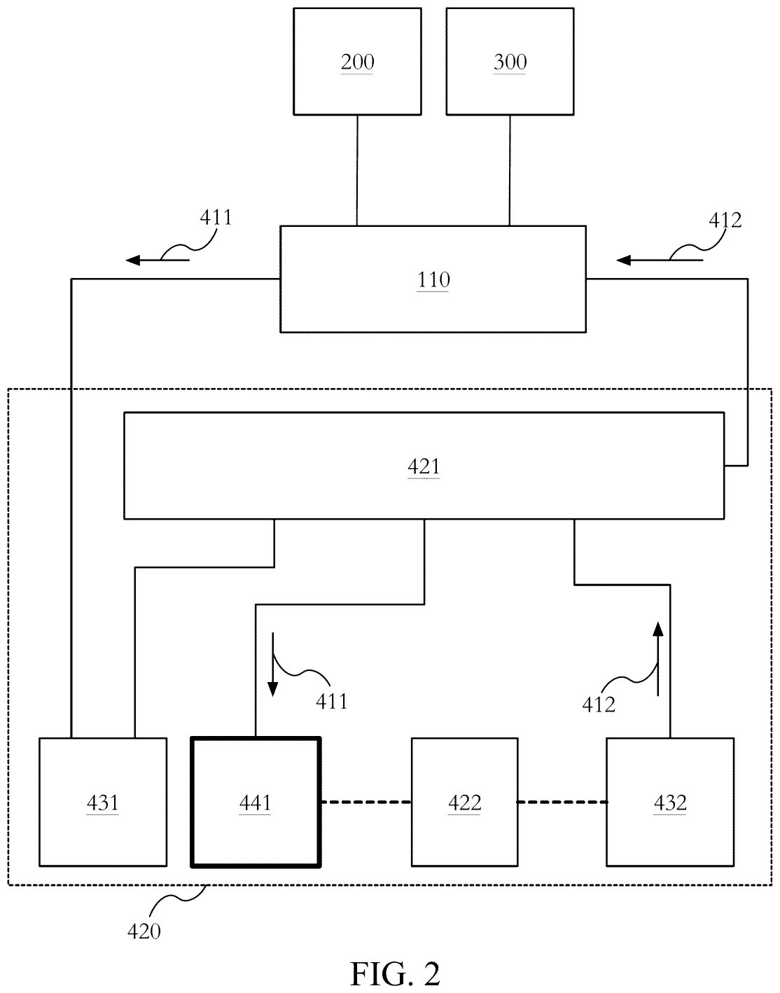

FIG. 1 and FIG. 2 are respectively a schematic diagram showing hardware architecture of a network device with a service function chain and a schematic structural diagram of virtual service nodes and a service function chain according to an embodiment. The network device with a service function chain (hereinafter referred as the network device 100) includes a physical network interface 110, a storage unit 120, and a processing unit 130.

For the inside of the network device 100, the processing unit 130 connects to the physical network interface 110 and the storage unit 120. For the outside, the physical network interface 110 respectively connects to a source 200 and a destination 300. The physical network interface 110 receives an input packet 411 or sends an output packet 412. The source 200 provides the input packet 411 to the network device 100. The network device 100 generates the output packet 412 to the destination 300. The source 200 and the destination 300 may be, but not limited to, personal computers, notebook computers, mobile apparatuses, tablet computers, cloud servers or Internet of Things devices.

The physical network interface 110 may be, but not limited to, an interface of wired Ethernet, or a transmission interface of a wireless network or mobile communication network. The number of the physical network interfaces 110 is not limited, so a plurality of network interfaces are illustrated in FIG. 1 for the convenience of description. The storage unit 120 stores an operating system 121, a plurality of virtual service nodes 422, and a virtual bridge 421.

The processing unit 130 executes the operating system 121, the virtual service nodes 422, and the virtual bridge 421. The virtual service node 422 can be implemented through virtualization techniques provided by open platform for NFV (OPNFV), OpenStack platform, or other service virtualization techniques. The virtual bridge 421 connects to each of the virtual service nodes 422 through a network, as shown in FIG. 2. Each of the virtual service nodes 422 is configured with a different network function. The type of the network function may be, but not limited to, a firewall, a load balancer, an intrusion detection system (IDS), an intrusion prevention system (IPS), a virtual private network gateway, a wide area network optimization controller (WOC), an application delivery controller (ADC), a session border controller (SBC), a network address translation (NAT), a domain name system server (DNS server), a dynamic host configuration protocol server (DHCP server), a network monitoring system or an online anti-virus service.

Each of the virtual service nodes 422 has a respective network configuration, which is called an endpoint network configuration. Besides, each virtual service node 422 operates the configured network function, and the virtual service node 422 may also execute a NAT program 122. The NAT program 122 is used for modifying configuration contents of network packets. The virtual bridge 421 has a bridge network configuration. Each endpoint network configuration and the bridge network configuration have different contents. The virtual service nodes 422 form a service function chain 420 according to their sequence, as shown by the dashed box in FIG. 2.

For different product requirements, developers may set different concatenation sequences of the virtual service nodes 422. For example, for the network device 100 with a secure access service edge (SASE) firewall function, the virtual service node 422 of the firewall may be arranged at the head of the service function chain 420, so that the input packet 411 can determine whether the destination 300 is valid at the first time. The network device 100 may additionally execute the virtual service node 422 of a VPN or the virtual service node 422 of a content delivery network.

In order to further describe each virtual service node 422 in the service function chain 420, virtual service nodes 422 with specific locations or functions are defined respectively. The virtual service nodes 422 at two ends of the service function chain 420 are respectively called as a head node 431 and an end node 432. The head node 431 receives the input packet 411 from the physical network interface 110. The end node 432 outputs the output packet 412 to the physical network interface 110.

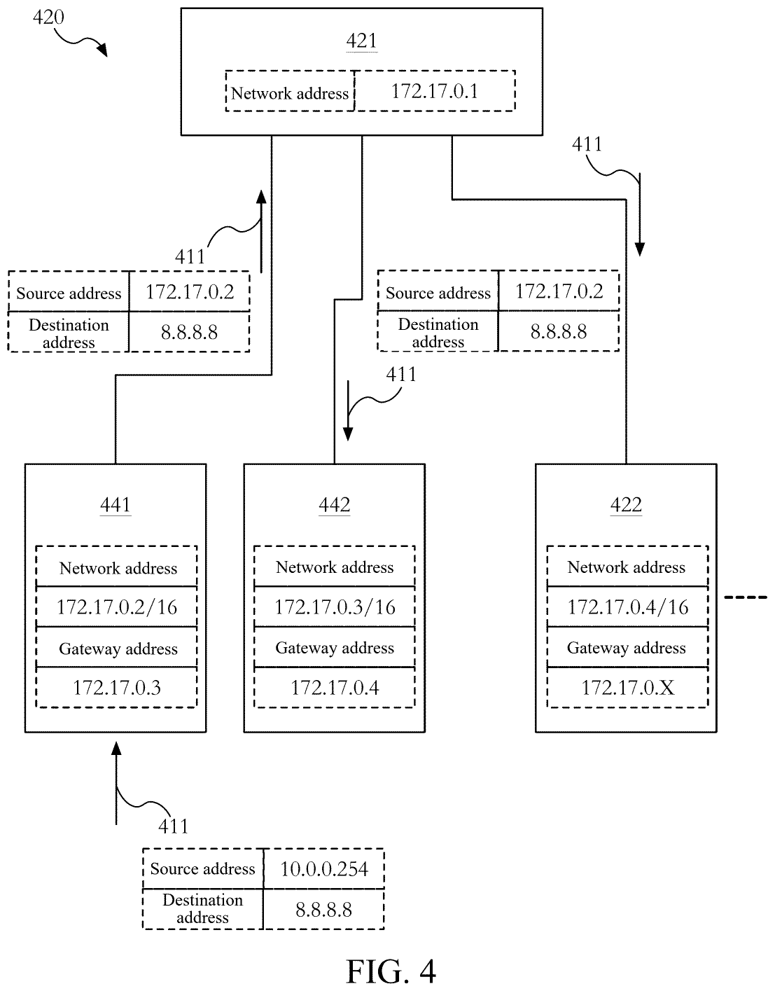

The input packet 411 flows through the virtual service nodes 422 according to the concatenation sequence. In order to distinguish the virtual service node 422 where the input packet 411 is located, the virtual service node 422 obtaining the input packet 411 is called a current node 441, as shown by the virtual service node 422 with a thick line box in FIG. 2. The next virtual service node 422 adjacent to the current node 441 is called a destination node 442, as shown in FIG. 4. Further, the current node 441 sends the input packet 411 that has flowed through the network function to the destination node 442.

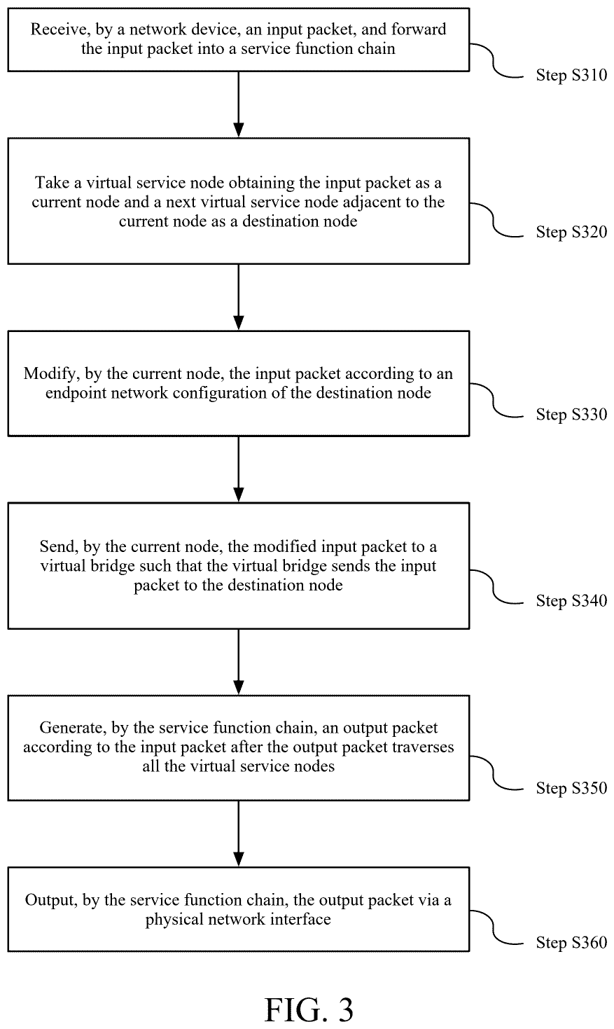

A specific description of the overall processing of the network device 100 is shown in FIG. 3. The processing flow of the network device 100 with a service function chain 420 includes the following steps:

Step S310: Receive, by the network device, an input packet, and forward the input packet into the service function chain.

Step S320: Take the virtual service node obtaining the input packet as a current node and the next virtual service node adjacent to the current node as a destination node.

Step S330: Modify, by the current node, the input packet according to an endpoint network configuration of the destination node.

Step S340: Send, by the current node, the modified input packet to a virtual bridge such that the virtual bridge sends the input packet to the destination node.

Step S350: Generate, by the service function chain, an output packet according to the input packet after the output packet traverses all the virtual service nodes.

Step S360: Output, by the service function chain, the output packet via a physical network interface.

First, the physical network interface 110 of the network device 100 connects to a source 200 and a destination 300. The source 200 sends the input packet 411 to the network device 100. After the physical network interface 110 receives the input packet 411, the processing unit 130 sends the input packet 411 to a head node 431. Since the head node 431 obtains the input packet 411, the current head node 431 may also be the current node 441. In contrast, the next virtual service node 422 adjacent to the head node 431 is the destination node 442.

The head node 431 performs a NAT program 122 on the input packet 411 according to the endpoint network configuration of the destination node 442 to modify a network configuration of the input packet 411. A gateway address of the head node 431 is set as an IP address of the destination node 442. Each of the virtual service nodes 422 is configured with same routing rules. Therefore, the virtual service nodes 422 can transmit the input packet 411 to the virtual bridge 421 and the destination node 442 according to the routing rules. The head node 431 sends the modified input packet 411 to the virtual bridge 421. The virtual bridge 421 forwards the input packet 411 to the destination node 442. When the destination node 442 receives the input packet 411, the virtual service node 422 receiving the input packet 411 (i.e., the aforementioned destination node 442) becomes the new current node 441.

The new current node 441 repeats step S330 and step S340, so that the input packet 411 sequentially flows through the virtual service nodes 422 according to the concatenation sequence. The concatenation sequence may be realized by means of a file script and the like, and the concatenation sequence is stored in the storage unit 120. The processing unit 130 may load the concatenation sequence to each of the virtual service nodes 422 when creating the virtual service nodes 422. Alternatively, each virtual service node 422 mounts a storage volume or container to a designated memory address or a designated location of an operating system 121. Each virtual service node 422 may obtain the concatenation sequence through network connection or internal dispatching of the processing unit 130.

As shown in FIG. 4, FIG. 4 shows an example where there are two virtual service nodes 422 and one virtual bridge 421, but the number of the virtual service nodes 422 is not limited thereto. The bridge network configuration is “172.17.0.1/16”, and the network configurations of the two virtual service nodes 422 are respectively “172.17.0.2/16” and “172.17.0.3/16”. The dashed boxes in FIG. 4 are the network configurations of the device (with no reference numerals). The two virtual service nodes 422 respectively connect to the virtual bridge 421. It is assumed that the input packet 411 is transmitted from the virtual service node 422 on the left to the virtual service node 422 on the right in FIG. 4. Therefore, the virtual service node 422 on the left becomes the current node 441. The virtual service node 422 on the right is the destination node 442.

The current node 441 executes the NAT program 122 to modify a source address “10.0.0.254/24” of the input packet 411 to “172.17.0.2”. Next, the current node 441 matches the stored routing rules, for example, executes a routing command of default via 172.17.0.3 in a UNIX environment. The modified input packet 411 is sent to the virtual bridge 421. The virtual bridge 421 forwards the input packet 411 to the destination node 442. The node on the right in FIG. 4 is one of the plurality of virtual service nodes 422. A gateway address of the virtual service node 422 on the right in FIG. 4 is a network address of the next virtual service node 422, so the gateway address of this virtual service node 422 in FIG. 4 is “172.17.0.X”

After the input packet 411 traverses each of the virtual service nodes 422, the input packet 411 is sent to the end node 432. After the end node 432 performs the NAT program 122 on the input packet 411, the modified input packet 411 is sent to the virtual bridge 421. The virtual bridge 421 sends the input packet 411 to the physical network interface 110. The network packet outputted to the physical network interface 110 is called the output packet 412. In other words, the head node 431 of the service function chain 420 obtains the input packet 411, and the end node 432 outputs the output packet 412. Then, the physical network interface 110 sends the output packet 412 to the destination 300.

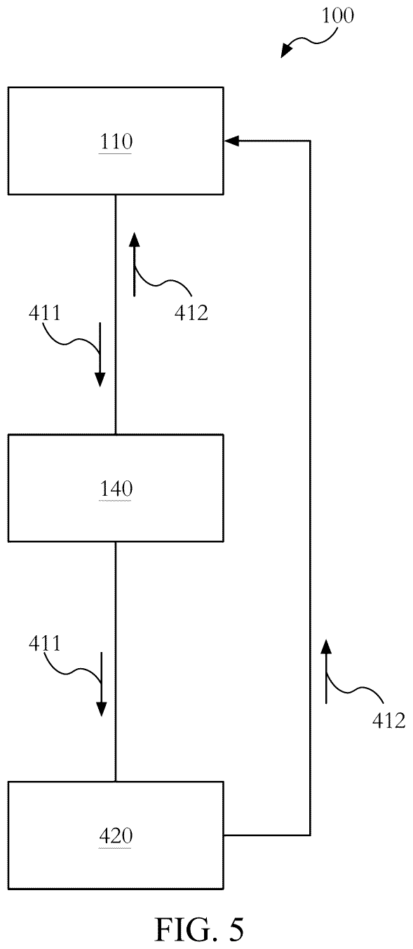

In an embodiment, the processing unit 130 establishes a virtual wide area network interface 140 (WAN), as shown in FIG. 5. The virtual wide area network interface 140 connects between the physical network interface 110 and the service function chain 420 through a network. The virtual wide area network interface 140 performs NAT on the input packet 411 to modify the network address of the input packet 411 such that the modified network packet conforms to a network segment of the virtual service node 422. The virtual wide area network interface 140 sends the modified input packet 411 to the service function chain 420 and the head node 431.

After the input packet 411 traverses each of the nodes, the end node 432 sends the output packet 412 to the virtual bridge 421. The virtual bridge 421 performs NAT on the output packet 412 to modify the network address of the output packet 412. The virtual bridge 421 sends the modified output packet 412 to the physical network interface 110.

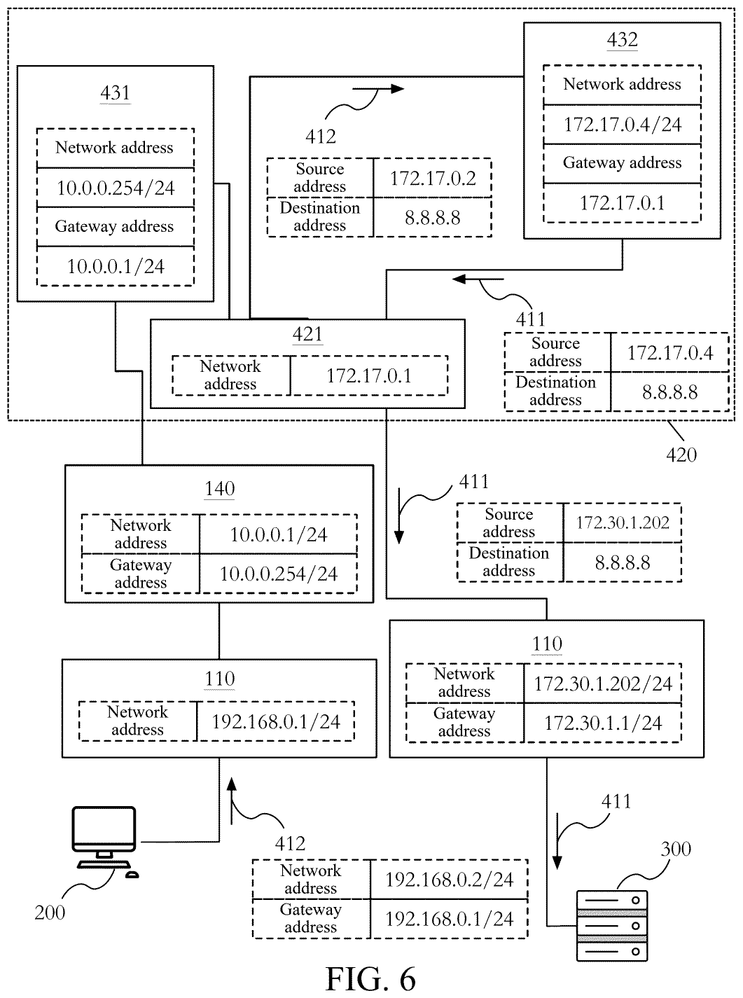

In an embodiment, the virtual wide area network interface 140 modifies the network configuration of the received input packet 411 and sends the modified input packet 411 to the head node 431. First, when the input packet 411 flows through the virtual wide area network interface 140, the processing unit 130 modifies the network address of the input packet 411. In order to explain the network addresses from different sources, different network addresses are respectively defined as follows. The network address of the end node 432 is called an end network address. The source address of the input packet 411 is called a head source address. The virtual wide area network interface 140 refers to the end network address, writes the end network address into the head source address (with no reference numeral) of the input packet 411, and writes the gateway address (with no reference numeral) of the input packet 411 with the network address of the destination node 442, as shown in FIG. 6.

The virtual wide area network interface 140 sends the modified input packet 411 to the head node 431, such that the input packet 411 traverses all the virtual network nodes until the end node 432. When the end node 432 obtains the input packet 411, the end node 432 performs the NAT program 122 on the input packet 411. The end node 432 writes the head source address into the source address of the input packet 411 to generate the output packet 412. The end node 432 sends the output packet 412 to the physical network interface 110 or the virtual wide area network interface 140. By replacing the end network address, the head node 431 can avoid the problem of conntrack that may be produced in different versions of the operating system 121. Since the source address of the end node 432 when sending the output packet 412 is the head source address, when the NAT program 122 is performed in the physical network interface 110 or the virtual wide area network interface 140, the problem of conntrack caused by the same network address can be avoided.

In FIG. 6, the physical network interface 110 respectively connects to the source 200 and the destination 300. The source 200 sends requirements of Ping to the destination 300. The network configuration of the source 200 is “network address: 192.168.0.2/24” and “gateway address: 192.168.0.1/24”. The network configuration of the destination 300 is “network address: 8.8.8.8”. The network configuration of the physical network interface 110 corresponding to the source 200 is “192.168.0.1/24”. The network configuration of the physical network interface 110 corresponding to the destination 300 is “172.30.1.202/24” and “gateway address: 172.30.1.1/24”. The network configuration of the virtual wide area network interface 140 is “network address: 10.0.0.1/24” and “gateway address: 10.0.0.254/24”.

The source 200 sends the input packet 411 to the network device 100. The input packet 411 sequentially flows through the physical network interface 110 and the virtual wide area network interface 140 to the service function chain 420. While the input packet 411 flows to the head node 431, the processing unit 130 performs the NAT program 122 on the input packet 411 to modify the network address of the input packet, and the modified network address is “network address: 10.0.0.1/24”. The physical network interface 110 transmits the modified input packet 411 to the virtual wide area network interface 140. The virtual wide area network interface 140 then transmits the input packet 411 to the service function chain 420. For the transmission of the input packet 411 at the service function chain 420, reference may be made to FIG. 4 and the description thereof.

When the input packet 411 arrives at the end node 432, the end node 432 modifies the source address of the input packet 411 to “172.17.0.4/24” when performing the NAT program 122. After the modification of the input packet 411 is completed, the end node 432 generates the output packet 412 to the virtual bridge 421 according to the routing rules, rather than sends the output packet 412 to the next virtual service node 422. The virtual bridge 421 performs the NAT program 122 on the output packet 412 to modify the source address to “172.30.1.202”. The virtual bridge 421 enables the output packet 421 to be sent to the destination 300 via the physical network interface 110 according to the routing rules.

The network device 100 and processing method with a service function chain 420 not only provide the service function chain 420 that can be deployed rapidly, but also enable the input packet 411 to be transmitted layer by layer according to the sequence of the virtual service nodes 422, thereby reducing the service deployment cost of engineers for the network device 100.

What is claimed is:

1. A network device with a service function chain, comprising:
a physical network interface, receiving an input packet or sending an output packet;
a storage unit, storing a plurality of virtual service nodes and a virtual bridge, the virtual bridge connecting to the virtual service nodes, the virtual service nodes forming a service function chain according to their sequence, and each of the virtual service nodes having an endpoint network configuration; and
a processing unit, connecting to the physical network interface and the storage unit, the processing unit executing the virtual service nodes and the virtual bridge, and the processing unit forwarding the input packet into the service function chain,
wherein the virtual service node obtaining the input packet is a current node, the next virtual service node adjacent to the current node is a destination node, the current node modifies the input packet according to an endpoint network configuration of the destination node, and the current node sends the modified input packet via the virtual bridge to the destination node until the output packet is generated by the service function chain after traversing all the virtual service nodes; and
the processing unit establishes a virtual wide area network interface, the virtual wide area network interface connects to the physical network interface and the service function chain through a network, the virtual wide area network interface performs a NAT program on the input packet to modify a network address of the input packet, and the virtual wide area network interface sends the modified input packet to the service function chain.

2. The network device with a service function chain according to claim 1, wherein an end node of the service function chain sends the output packet to the virtual bridge, the virtual bridge performs the NAT program on the output packet to modify the network address of the output packet, and the virtual bridge sends the modified output packet to the physical network interface.

3. The network device with a service function chain according to claim 1, wherein the virtual service nodes at two ends of the service function chain are respectively a head node and an end node, the head node receiving the input packet, and the end node sending the output packet.

4. The network device with a service function chain according to claim 3, wherein the processing unit refers to an end network address of the endpoint network configuration of the end node and writes the end network address into a head source address of the input packet, and the head node receives the input packet.

5. The network device with a service function chain according to claim 1, wherein each of the virtual service nodes is configured with a respective network function.

6. A processing method with a service function chain, a plurality of virtual service nodes being configured in a network device and forming a service function chain according to their sequence, the processing method with a service function chain comprising:
receiving, by the network device, an input packet, and forwarding the input packet into the service function chain;
establishing, by the network device, a virtual wide area network interface;
receiving, by the virtual wide area network interface, the input packet, and performing, by the virtual wide area network interface, a NAT program on the input packet to modify a network address of the input packet;
sending, by the virtual wide area network interface, the modified input packet to the service function chain;
taking the virtual service node obtaining the input packet as a current node and the next virtual service node adjacent to the current node as a destination node;
modifying, by the current node, the input packet according to an endpoint network configuration of the destination node;
sending, by the current node, the modified input packet to a virtual bridge such that the virtual bridge sends the input packet to the destination node;
generating, by the service function chain, an output packet according to the input packet after the input packet traverses all the virtual service nodes; and
outputting, by the service function chain, the output packet via a physical network interface.

7. The processing method with a service function chain according to claim 6, wherein the generating, by the service function chain, the output packet according to the input packet after the output packet traverses all the virtual service nodes comprises:
sending, by an end node of the service function chain, the output packet to the virtual bridge;
performing, by the virtual bridge, the NAT program on the output packet to modify the network address of the output packet; and
sending, by the virtual bridge, the modified output packet to the physical network interface.

8. The processing method with a service function chain according to claim 6, wherein the modifying, by the current node, the endpoint network configuration of the destination node into the input packet comprises:
taking the two virtual service nodes at ends of the service function chain respectively as a head node and an end node; and
sending, by the network device, the input packet to the head node.

9. The processing method with a service function chain according to claim 8, further comprising:
obtaining, by the network device, an end network address of the endpoint network configuration of the end node;
writing, by the network device, the end network address into a head gateway address of the input packet; and
sending, by the network device, the modified input packet to the head node.
